(19) United States
(12) Patent Application Publication
(10) Pub. No.: US 2010/0021298 A1
(43) Pub. Date: Jan. 28, 2010

(54) Wind Turbine Blade Position Determination System

(76) Inventor: Ingemann Hvas Sandvad, Singapore (SG)

Correspondence Address: ST. ONGE STEWARD JOHNSTON & REENS, LLC, 986 BEDFORD STREET, STAMFORD, CT, 06905-5619, US

(21) Appl. No.: 12/570,930

(22) Filed: Sep. 30, 2009

Related U.S. Application Data
(63) Continuation of application No. PCT/DK2008/000125, filed on Mar. 31, 2008.

(30) Foreign Application Priority Data
Mar. 30, 2007 (DK) PA 2007 00499

(51) Int. Cl. F03D 11/00

(52) U.S. Cl. 416/1; 416/61

(57) ABSTRACT

A system for determining the position of at least a part of a wind turbine blade by wireless transmission of a signal includes a transmitter arrangement attached to a wind turbine blade, a receiving arrangement, and at least one position calculation computer, wherein the signal is wirelessly transmitted from the at least one transmitter arrangement to the receiving arrangement, and wherein the position calculation computer calculates position indicative data on the basis of the signal received by the receiving arrangement and wherein the position indicative data indicates a position of at least a part of the wind turbine blade.

### CROSS-REFERENCE TO RELATED APPLICATIONS

The present application is a continuation of pending International patent application PCT/DK2008/000125 filed on Mar. 31, 2008 which designates the United States and claims priority from Danish patent application PA 2007 00499 filed on Mar. 30, 2007, the content of which is incorporated herein by reference.

### FIELD OF THE INVENTION

The invention relates to a system determining the blade position of a wind turbine.

### BACKGROUND OF THE INVENTION

In relation to optimizing the operation of wind turbines, many surveillance technologies have been disclosed in order to anticipate errors and in relation to optimize the energy production of the wind turbine generators.

International patent application WO 2005/068834 relates to a method for determining the position of position indicators placed on the blades of a wind turbine by means of position indicators that can be GPS receivers receiving signal from three GPS satellites, enabling that the position can be established. The position can be determined on the basis of signals from local transmitters such as transmitters placed in fixed positions in and/or around the wind turbine.

A problem in relation with the prior art is that GPS receivers have to be mounted in the blades and consequently resulting in that mounting and maintenance may become quite complex and costly. A further problem of the above-mentioned prior art is that it requires that data and/or signal processing is performed in the blade, for the purpose of determining a relative or absolute position of the blade or blade portions of the blade. A further problem related to mounting of relative sensitive electronics such as a GPS receiver in the blade is that equipment needs to be very robust to e.g. resist relative large difference in temperature and mechanic stress caused by vibrations and rotation of the blade.

### SUMMARY OF THE INVENTION

The invention relates to a system for determining the position of at least a part of a wind turbine blade by wireless transmission of a signal comprising
a transmitter arrangement attached to a wind turbine blade,
a receiving arrangement,
and at least one position calculation computer,
wherein said signal is wirelessly transmitted from said at least one transmitter arrangement to said receiving arrangement, and wherein said position calculation computer calculates position indicative data on the basis of said signal received by said receiving arrangement and wherein said position indicative data indicates a position of at least a part of said wind turbine blade.

In an embodiment of the invention, said passive position signal is free of position indicative data.

In an embodiment of the invention, said transmitter arrangement comprises at least two transmitters preferably mounted in mutually different positions of the wind turbine blade.

In an embodiment of the invention, said receiving arrangement comprises at least two receivers.

In an embodiment of the invention, said signal is a signal from where the position is calculated by means of a triangulation calculation.

In an embodiment of the invention, said signal is a signal from where the position is calculated by means of a trilateration calculation.

In an embodiment of the invention, said signal is a signal from where the position is calculated by means of a multilateration calculation.

In an embodiment of the invention, said transmitter arrangement is at least partly implemented by means of RFID (RFID: Radio Frequency IDentification) tags mounted in/on said wind turbine blade.

In an embodiment of the invention, said transmitter arrangement comprises a plurality of transmitters, transmitting signals to said receiving arrangement, thereby determining the position of a plurality of points of said wind turbine blade.

It is a very advantageous feature according to an embodiment of the invention, that several transmitters may be comprised by a wind turbine blade. By means of determining the position of a plurality of points of the wind turbine blade, it is possible to map the blade completely or partly, thereby determining possible twists or deflection of the wind turbine blade.

Moreover, the invention relates to a method of determining the position of at least a part of a wind turbine blade comprising the steps of sending a predefined signal from at least one transmitter arrangement positioned in a predefined position in relation to said wind turbine blade, receiving said signal in at least three receivers, establishing position indicative data on the basis of a calculation performed in relation to a position calculation computer.

In an embodiment of the invention, said signal is free of position indicative data.

In an embodiment of the invention, said calculation is performed as a triangulation, trilateration and/or multilateration on the basis of said received signal.

In an embodiment of the invention, said the signal is established by a transmitter arrangement is at least partly formed by means of RFID tags mounted in/or said wind turbine blade.

Moreover, the invention relates to a wind turbine blade comprising at least one transmitter arrangement for wireless transmission of at least one signal, wherein said transmitter arrangement is at least partly formed by means of RFID tags.

In an embodiment of the invention, said signal is utilized to determine the position of said wind turbine blade and/or a portion thereof, external to the wind turbine blade.

In an embodiment of the invention, said signal is established for determination of l absolute or relative position of the transmitter arrangement, the wind turbine blade, or portions of the wind turbine blade.

In an embodiment of the invention, said transmitter arrangement is incorporated in or mounted on the wind turbine blade.

In an embodiment of the invention, said at least two transmitters comprises electromagnetic transmitters.

In an embodiment of the invention, said signals are non-encoded with position indicative data.

In an embodiment of the invention, said wind turbine comprising a wind turbine blade.

Moreover, the invention relates to the use of wireless signals for determination of the position of at least a part of a wind turbine blade, wherein the wireless signals are transmitted wirelessly from a wind turbine blade and wherein the signals are non-encoded with position indicative data.

In an embodiment of the invention, the above-described use of wireless signals is performed in connection with the above-described wind turbine blade.

In an embodiment of the invention, said signal(s) is (are) utilized to determine the position of said wind turbine blade and/or a portion thereof, external to the wind turbine blade.

In an embodiment of the invention, said signal is established for determination of external absolute or relative position of the transmitter arrangement, the wind turbine blade, or portions of the wind turbine blade.

Passive position indicative data is in accordance with the present invention understood as a signal that comprises no position indicative data per se, but the signal becomes position indicative when received at the receiver, i.e. the position is determined at the receiver on the basis of the signal sent from the transmitter. This may be a very simple and short burst, e.g. a radio or ultrasonic signal.

It is a very advantageous feature according to an embodiment of the invention that the wind turbine blade comprises nothing but a simple transmitter. This means that no complex circuits, receiving units or the like must be implemented into the wind turbine blade which is the case in the prior art systems. These must both have means for receiving a signal, means for processing and means for re-transmitting the position indicative data. This entails in addition that the transmitter may easily and at low cost be retrofitted to existing wind turbine blades.

The position determination of the present invention may be used for optimizing the use energy production of the wind turbine. Moreover, the position determination according to the invention may be used as an equivalent determination of the position of a wind turbine blade for double checking the conventional blade position data, e.g. the blade angle.

In an embodiment of the invention, said transmitter arrangement is incorporated in the wind turbine blade.

In an embodiment of the invention, said transmitter arrangement is mounted on the wind turbine blade.

According to an advantageous embodiment of the invention, the transmitter arrangement may be retrofitted to the wind turbine blade. Moreover it is possible easily to replace a defect or outdated transmitter.

In an embodiment of the invention, said signal is utilized to produce position indicative data determining the position of said wind turbine blade at least partly, by means of a calculation performed by a position calculation computer.

In an embodiment of the invention, said at least two transmitters comprises electromagnetic transmitters.

In an embodiment of the invention, said at least two transmitters comprises ultrasonic transmitters.

In an embodiment of the invention, said determination of the position of said wind turbine blade and/or a portion thereof is performed independently to the azimuth angle of the wind turbine.

Moreover, the invention relates to a system for wireless transmission of a signal comprising
at least one transmitter arrangement related to a wind turbine blade,
a receiving arrangement
and at least one position calculation computer,
wherein said signal is wirelessly transmitted from said at least one transmitter arrangement to said at least three receivers, and wherein said position calculation computer may produce position indicative data on the basis of said signal.

Position indicative data is according to the present invention understood as data that at least partly indicates the absolute or relative position of the wind turbine blade.

In an embodiment of the invention, said signal is free of position indicative data.

In an embodiment of the invention, said transmitter arrangement comprises at least two transmitters preferably mounted in mutually different positions of the wind turbine blade.

In an embodiment of the invention, said receiving arrangement comprises at least three receivers.

In an embodiment of the invention, said wireless transmission is preferably an electromagnetic transmission.

In an embodiment of the invention, said wireless transmission is preferably an ultrasonic transmission.

In an embodiment of the invention, said signal represents the position of the wind turbine blade partly.

The signal may according to an alternative embodiment of the invention partly represent the position of the blade for example if the data is combined with position indicative data which may be derived from an external source with reference to the transmitter. Moreover, the signal may comprise or be followed by an identification of the transmitter or the wind turbine blade.

In an embodiment of the invention, said receiving arrangement and/or said transmitter are at least partly implemented by means of RFID tags.

According to an embodiment of the invention, the transmitters T and receivers R are implemented by means of RFID-tags. RFID (radio frequency identification tag) is understood as an identification label or tag capable of transmitting data via radios signals. the process of using an electrical transponder which stores information that may be used to e.g. identify the item to which the tag is attached, similar to the way in which a bar code on a label stores information that can be used to identify the item to which the label is attached. RFID tags may contain antennas to enable them to receive and respond to radio-frequency queries from a transmitter, e.g. a RFID transmitter or transceiver. It is very advantageous that the transmitter and/or the receiver may be implemented by means of utilizing active RFID tags, in that these are very inexpensive and consumes very little energy. The receivers R in the receiving arrangement may be implemented by the sol-called readers, which are understood as a device that uses one or more antennas to emit radio waves and receive response signals from the RFID-tags. The reader may decode signals from the transmitter and communicate this information in digital form to the position calculation computer. Moreover, these are very small and plane, which makes them very applicable for mounting on the wind turbine blades, in level with the surface of the blades.

In an embodiment of the invention, said transmitter arrangement comprises at least one directional transmitter

In an embodiment of the invention, said transmitter arrangement comprises at least one directional receiver.

In an embodiment of the invention, said transmitter arrangement comprises at least one transponder.

A transponder is according understood a device that may be remotely activated and remotely energized.

Furthermore, the invention relates to use of wireless signals for determination of the position of at least a part of a wind turbine blade.

In an embodiment of the invention, said calculation is performed utilizing data representing signal time delay between transmission and reception of said signal.

In an embodiment of the invention, said calculation is performed utilizing data representing signal time difference between receptions of said signal in said at least three receivers.

Moreover, the invention relates to a method of determining the deflection of at least one wind turbine blade in a system comprising at least one wind turbine blade,
wherein at least one transmitter T is positioned in a predetermined position in relation to said wind turbine blade and at least one receiver,
wherein said transmitter T is adapted for transmission of a signal,
wherein said receiver is adapted for receipt of said signal),
wherein the distance (D1, D2) between the transmitter and the receiver is calculated by means of measuring the time of arrival of the signal at the receiver thereby determining the deflection of said wind turbine blade.

By means comparing a measured distance with a predetermined reference parameter it may be determined if the wind turbine blade bends or deflects too much which may involve collision with the e.g. the tower. This way a very advantageous feature has been obtained.

Furthermore, the invention relates to a wind turbine comprising a wind turbine blade as described above.

### BRIEF DESCRIPTION OF THE DRAWINGS

The invention will be described in the following with reference to the figures in which

FIG. 1 illustrates a modern wind turbine 1,

FIG. 2 illustrates a system for wireless transmission of a passive position signal PPS according to an embodiment of the invention,

FIG. 3 illustrates a system for wireless transmission of a passive position signal PPS according to an embodiment of the invention and

FIGS. 4a and 4b illustrate a system for determining the position of a wind turbine blade according to an alternative embodiment of the invention.

### DETAILED DESCRIPTION OF THE INVENTION

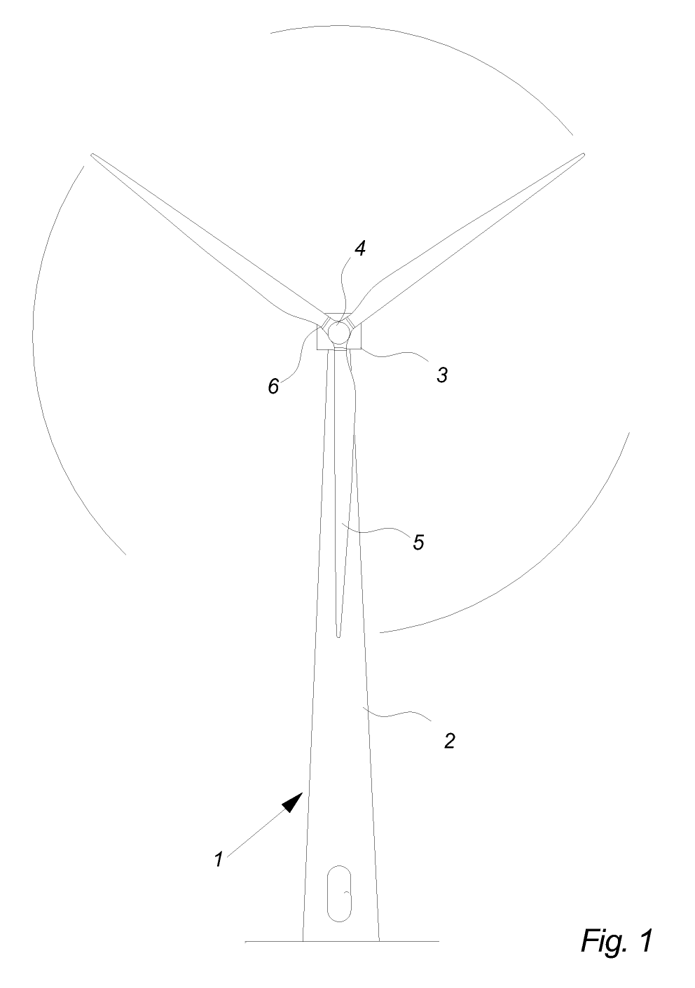

FIG. 1 illustrates a modern wind turbine 1. The wind turbine 1 comprises a tower 2 positioned on a foundation. A wind turbine nacelle 3 with a yaw mechanism is placed on top of the tower 2.

A low speed shaft extends out of the nacelle front and is connected with a wind turbine rotor through a wind turbine hub 4. The wind turbine rotor comprises at least one rotor blade e.g. three rotor blades 5 as illustrated.

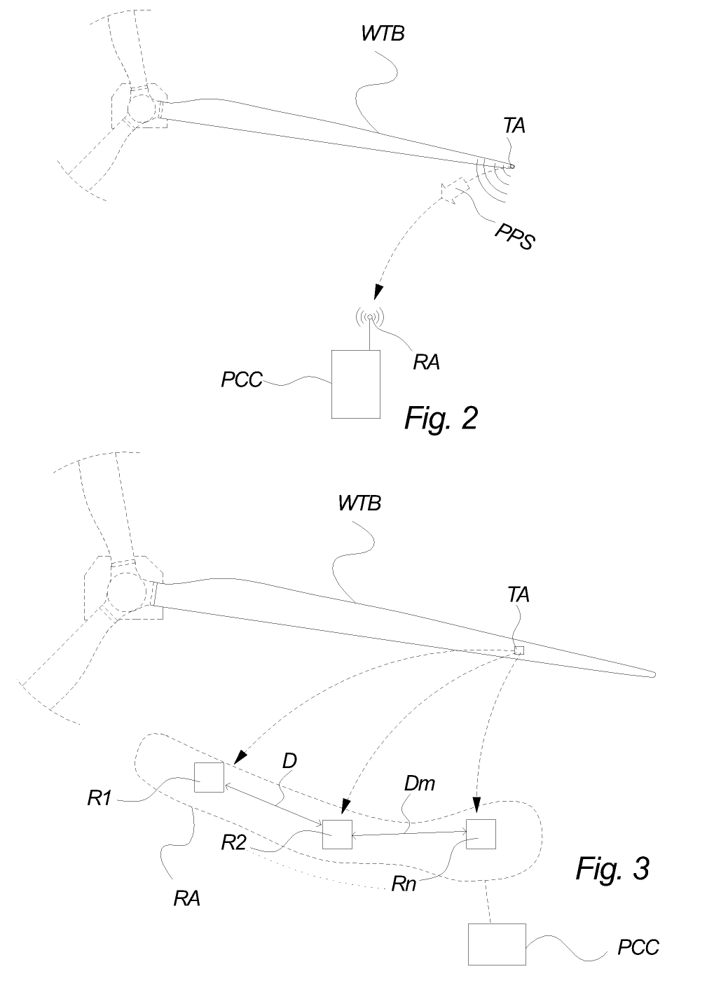

FIG. 2 illustrates a system for wireless transmission of a so-called passive position signal PPS according to an embodiment of the invention.

The term passive position signal PPS is introduced to avoid confusion between the signal reflecting the position of the wind turbine blade in the geometric space and other signals mentioned throughout this application. Hence, passive position signal PPS defines a signal transmitted from the transmitter arrangement TA attached to the wind turbine blade throughout the rest of the detailed description.

The figure illustrates a wind turbine blade WTB and a receiving arrangement RA related to a position calculation computer PCC. One or several transmitters T are located in a transmitter arrangement TA positioned in a predefined position in relation to the wind turbine blade WTB. The transmitters T comprise means for transmitting wireless signals. The signals to be transmitted wirelessly may be of different types, e.g. a radio communication signal, an ultrasonic signal, light signal, etc. The meaning of a so-called passive position signal PPS is that the signal does not comprise data that may serve as basis for calculation of the position, such data may e.g. be a time stamp, satellite information etc.

In one embodiment, the information comprised in the passive position signal PPS is an identification of the transmitter from which the passive position signal PPS is transmitted.

The passive position signal PPS is received by the receiving arrangement and becomes position indicative due to calculation typically performed by the position calculation computer PCC, i.e. the position is determined on the basis of the one or typically several signals sent from the transmitter arrangement TA. In other words, the passive position signal PPS may be established according to an embodiment of the invention in a relatively robust primitive way, whereas the main signal processing may be performed externally

The receiving arrangement RA may typically comprise one or several receivers R for receiving signals sent by the transmitter arrangement TA. The receivers R may in accordance with embodiments of the invention be positioned in a multitude of locations within the scope of the invention, e.g. on the ground, in relation to the tower T, at other wind turbines in a wind farm, etc.

The transmitter(s) related to the transmitter arrangement TA may be any device or simple circuit comprising means for transmitting a signal according to the above mentioned examples.

Due to the simplicity of the transmitters, the power consumption of these may be very low, which means that the distributed transmitters related to the wind turbine blade WTB may be supplied by locally generated energy such as solar energy or the like. Alternatively the energy may come from batteries, e.g. long-life battery cells or another energy storage device.

A further alternative to the above mentioned active transmitters are passive transmitters fed externally by means of energy. A type of passive transmitter which may be applied according to an embodiment of the invention is a transponder or any kind of transmitter which may be fed with energy externally.

This signal transmitted from the transmitter T may be a very simple and short burst, e.g. a radio frequency.

The position calculation computer PCC may calculate the position of the transmitter T located in relation to the wind turbine blade WTB by measuring the distance between the transmitter T and three or more receivers R. From a measurement of the time delay between transmission and reception of the signal it is possible according to an embodiment of the invention to calculate the distance between the transmitter T and the receivers R respectively, since the signal travels at a known speed.

A significant advantage of the invention is that the position calculation computer PCC may be positioned externally to the wind turbine blades WTB. This implies that the position calculation computer PCC may be easily maintained and e.g. software updated.

The position calculation computer PCC may be a software- or hardware-implemented integrated part of the wind turbine controller WTC, typically located in relation to the wind turbine WT. This may be advantageous, in that data do not need to be no re-directed which may cause critical delays. Alternatively, the position calculation computer PCC may be an independent stand-alone device, which may send a message to a proper suitable recipient, either continuously, on demand or if a particular event occurs.

The absolute or relative position of the wind turbine blade WTB or blade portion may be established in many different ways. A few of many applicable embodiments within the scope of the invention are mentioned in the following.

By determining the position of, and distance to, at least three receivers, the position calculation computer PCC is able to compute the position of the transmitter, and thereby the wind turbine blade WTB using e.g. a multilateration, trilateration or triangulation process. On the basis hereof, the wind turbine may react, if the position of the wind turbine blade WTB is critical, e.g. by stopping the wind turbine.

Trilateration is understood as a method of determining the relative positions of objects using the geometry of triangles in a similar fashion as triangulation. Unlike triangulation, which uses angle measurements (together with at least one known distance) to calculate the subject's location, trilateration uses the known locations of two or more reference points, and the measured distance between the subject and each reference point. The distance can be measured differently by means of utilizing different techniques, including RSSI (RSSI: Received Signal Strength Indicator) and ToA (ToA: Time-of-Arrival). RSSI is understood as technique for measuring of the signal power at the receiver. The transmission power loss can hereby be translated into a distance. The ToA is understood as the technique of recording the propagation time and by knowing the signal speed the propagation time can be translated into a distance. To accurately and uniquely determine the relative location of a point on a 2D plane using trilateration alone, generally at least 3 reference points are needed. These reference points are according to an embodiment of the invention understood as the receivers R or alternatively the transmitter T. The trilateration process needs 4 coplanar references (receivers R) to compute 3D position.

In accordance with another embodiment of the invention, the position of the wind turbine blade is calculated on the basis of a multilateration process.

Multilateration, also known as hyperbolic positioning, is according to an embodiment of the invention understood as the process of determining the position of a transmitter T by accurately calculating the TDoA (TDoA: time difference of arrival) of a signal emitted from the transmitter T to three or more receivers R. It also refers to the case of locating a receiver R by measuring the time difference of arrival of a signal transmitted from three or more synchronized transmitters T. If a pulse is emitted from a platform, it will arrive at slightly different times at two spatially separated receiver R sites, the time difference of arrival being due to the different distances of each receiver R from the platform. In fact, for given locations of the two receivers R, a whole series of emitter locations would give the same measurement of time difference of arrival. Given two receiver locations and a known time difference of arrival, the locus of possible transmitter T locations is a hyperboloid. In other words, with two receivers R at known locations, an emitter can be located onto a hyperboloid. Note that the receivers R do not need to know the absolute time at which the pulse was transmitted—only the time difference is needed.

Consider now a third receiver R at a third location. This would provide a second time difference of arrival measurement and hence locate the transmitter T on a second hyperboloid. The intersection of these two hyperboloids describes a curve on which the emitter lies. If a fourth receiver R is now introduced, a third time difference of arrival measurement is available and the intersection of the resulting third hyperboloid with the curve already found with the other three receivers R defines a unique point in space. The transmitters T location is therefore fully determined in 3D.

In accordance with another embodiment of the invention, the position of the wind turbine blade is calculated on the basis of the triangulation process. Triangulation is understood as the process of finding coordinates and distance to a point by calculating the length of one side of a triangle, given measurements of angles and sides of the triangle formed by that point and two other known reference points, using the law of sinus. The angles may be determined by using the AoA technique (AoA: Angle of Arrival) which is a technique for determining the direction of propagation of a radio-frequency wave incident on an antenna array. The technique calculates the direction by measuring the TDoA (TDoA: Time difference of Arrival) at individual elements of the antenna array, from these delays the AoA can be calculated. Generally this TDoA measurement is made by measuring the difference in received phase at each element in the antenna array.

According to an embodiment of the invention, the position of the wind turbine blade is calculated on the basis of any combination of the multilateration, trilateration or triangulation processes. It is also possible to use other more primitive calculating or predetermination methods to calculate the relative position of a blade e.g. geometric projecting the position of the blade onto a plane in space, e.g. the horizontal X-Y plane.

During installation of a number of transmitters T and receivers R in accordance with the present invention, it is preferred to perform a calibration process of the equipment. This may be done by setting up some reference signals for comparison with measured data in relation to calculation computer PCC. This way, in some cases the calculation of whether the wind turbine blade WTB is in a critical condition may be optimized to avoid critical errors, such as the blade collides with the tower.

According to an embodiment of the invention, the transmitters T and receivers R are implemented by means of passive or active RFID-tags. RFID (radio frequency identification tag) is understood as an identification label or tag capable of transmitting data via radios signals. An RFID tag is understood as an electrical transponder which stores information that may be used to e.g. identify the item to which the transponder is attached, similar to the way in which a bar code on a label stores information that can be used to identify the item to which the label is attached. RFID tags may contain antennas to enable them to receive and respond to radio-frequency queries from a transmitter, e.g. a RFID transmitter or transceiver. Passive RFID tags are understood as tags without any permanent energy supply, these receive the energy, e.g. in the form of electromagnetic waves from an external source. Thus, passive RFID tags are understood as transponders which are activated when placed inside a magnetic field generated by an antenna. The induced current in the coil in turn charges a capacitor located inside the tag. Unlike passive RFID tags, active RFID tags have their own internal power source which is used to power any integrated circuits that generate the outgoing signal.

Furthermore, the RFID is understood as an automatic identification method, relying on storing and remotely retrieving data using devices called RFID tags or transponders.

An RFID tag is an object that may be applied e.g. to a product for the purpose of identification using e.g. electromagnetic waves.

An RFID tag may contain at least two parts. The first is an integrated circuit e.g. for storing and processing information, modulating and demodulating a (Radio Frequency) signal or other specialized functions. The second is an antenna structure for receiving and transmitting the signal.

A chipless RFID allows for discrete identification of tags without an integrated circuit, thereby allowing tags to be printed directly onto assets at a lower cost than traditional tags.

A transponder is in this application understood as a wireless communication, monitoring or control device that picks up and automatically responds to an incoming signal. The term transponder is a contraction of the words transmitter and responder and can be either passive or active.

A passive transponder allows e.g. a computer to identify an object. A passive transponder may be used with an active sensor that decodes and transcribes the data the transponder contains.

Simple active transponders may be used in identification systems. An example is an RFID device that transmits a coded signal when it receives a request from a monitoring or control point. The transponder output signal is tracked, so the position of the transponder can be constantly monitored. The input (receiver) and output (transmitter) frequencies are pre-assigned.

When RFID tags are applied as transmitter in accordance to the present invention, these may RF (RF: Radio Frequency) message with the identity of the tag, together with a UWB (Ultra Wide Band) pulse sequence which may be utilized for a better calculation of the position by the position calculation computer.

A passive position signal is understood as a data signal that comprises no position indicative data per se, but the signal becomes position indicative when the received signal is processed, typically by means of a position calculation computer PCC, where the position of the transmitter arrangement TA is determined at the receiver on the basis of the signal sent from the transmitter arrangement TA.

The position indicative data may be a relative position or absolute position, e.g. a unique point in space.

It is a very advantageous feature according to an embodiment of the invention, that the wind turbine blade comprises nothing but a simple transmitter. This means that no complex circuits, antennas or the like must be implemented into the wind turbine blade which is the case in the prior art systems which must both have means for receiving a signal and means for transmitting the re-transmitting the position indicative data.

FIG. 3 illustrates a system for wireless transmission of a passive position signal PPS according to an embodiment of the invention. The figure illustrates a wind turbine blade WTB comprising a transmitter arrangement TA transmitting a passive position signal PPS to a receiving arrangement RA which according to this example comprises three different receivers R1, R2, . . . Rn. The receivers R may be located anywhere, but must be located in three different positions. The receivers may be related to a position calculation computer PCC that may calculate a position of the transmitter T and thereby the wind turbine blade WTB. Four receivers may be utilized in an embodiment of the invention, where the trilateration process is used to calculate the position of the wind turbine blade WTB as explained above. In accordance with other embodiment of the invention, any number of receivers R may be utilized. The distances D, . . . , Dm between the receivers R may also as explained above be used for calculation of transmitters positioned in a predetermined relation to the wind turbine blade to determine the absolute or relative position of the wind turbine blade.

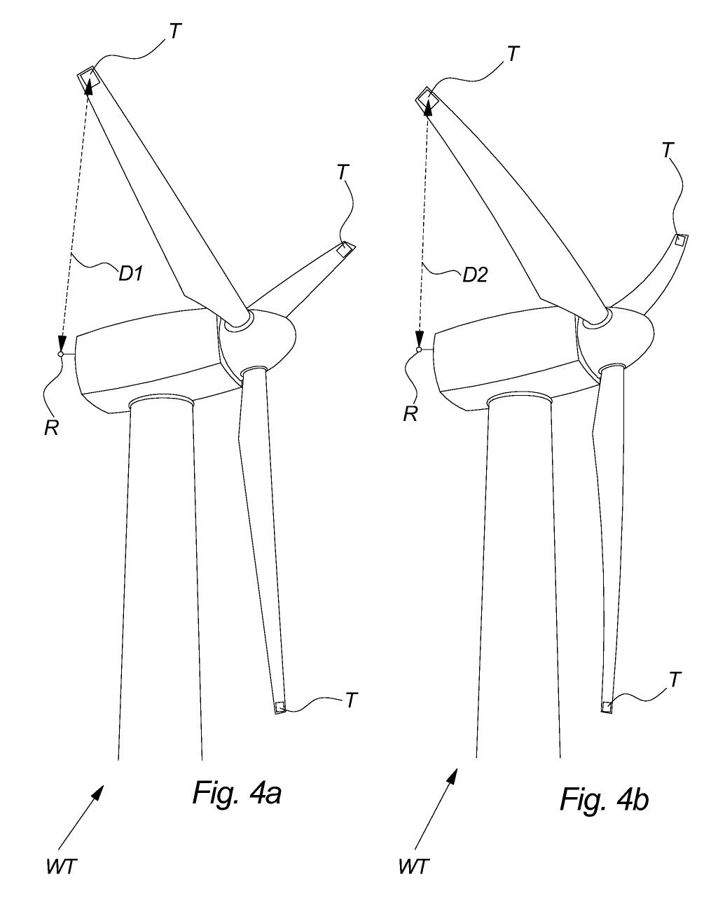

FIGS. 4a and 4b illustrates a system for determining the position of a wind turbine blade according to an alternative embodiment of the invention. In this embodiment, a receiver R is positioned on the nacelle of a wind turbine WT in the origin of the rotors circular rotation area. One or several signal transmitters T are positioned in relation to a wind turbine blade WTB, preferably in the end of the wind turbine blade WTB away from the center of the rotor. It is this way possible to determine the accurate distance between the transmitter T and the receiver R by means of transmitting a passive position signal PPS from the transmitter to the receiver, which when received by the receivers may be interpreted as a distance D1, D2, given that the travel speed of the signal is known. By means comparing a measured distance with a predetermined reference parameter it may be determined if the wind turbine blade WTB bends too much which may involve collision with the e.g. the tower. A signal may hence be transmitted from the receiver R to a wind turbine control FIG. 4b illustrates an example of a wind turbine with bended wind turbine blades WTB so the distance D2 between the transmitter T and the receiver R is smaller than the same distance D1 as illustrated with reference to FIG. 4a. This way it is possible to determine the bending of the wind turbine blades WTB.

1. A system for determining a position of at least a part of a wind turbine blade by wireless transmission of a signal comprising:
a transmitter arrangement attached to a wind turbine blade,
a receiving arrangement,
and at least one position calculation computer,
wherein said signal is wirelessly transmitted from said at least one transmitter arrangement to said receiving arrangement, and wherein said position calculation computer calculates position indicative data on the basis of said signal received by said receiving arrangement and wherein said position indicative data indicates the position of at least a part of said wind turbine blade.

2. The system according to claim 1, wherein said signal is free of position indicative data.

3. The system according to claim 1, wherein said transmitter arrangement comprises at least two transmitters mounted in mutually different positions of the wind turbine blade.

4. The system according to claim 1, wherein said receiving arrangement comprises at least two receivers.

5. The system according to claim 1, wherein the position indicative data is calculated by the position calculation computer by means of at least one of a triangulation, trilateration and multilateration calculation on the basis of said signal received by said receiving arrangement.

6. The system according to claim 1, wherein said transmitter arrangement is at least partly implemented by means of radio frequency identification tags mounted in or on said wind turbine blade.

7. The system according to claim 1, wherein said transmitter arrangement comprises a plurality of transmitters, transmitting signals to said receiving arrangement, thereby determining the position of a plurality of points of said wind turbine blade.

8. A method of determining a position of at least a part of a wind turbine blade comprising the steps of:
transmitting a predefined signal from at least
one transmitter arrangement mounted in or on said wind turbine blade,
receiving said signal by a receiving arrangement, and
establishing position indicative data on the basis of a calculation performed by a position calculation computer on the basis of said received signal.

9. The method according to claim 8, wherein said signal is free of position indicative data.

10. The method according to claim 8, wherein said calculation is performed as at least one of a triangulation, trilateration and multilateration on the basis of said received signal.

11. The method according to claim 8, wherein the signal established by said transmitter arrangement is at least partly formed by means of radio frequency identification tags mounted in or on said wind turbine blade.

12. A wind turbine blade comprising at least one transmitter arrangement for wireless transmission of at least one signal, wherein said transmitter arrangement is at least partly formed by means of radio frequency identification tags.

13. The wind turbine blade according to claim 12, wherein said signal is utilized to determine a position of at least a portion of said wind turbine blade, external to the wind turbine blade.

14. The wind turbine blade according to claim 12, wherein said signal is established for determination of an absolute or relative position of the transmitter arrangement, the wind turbine blade, or portions of the wind turbine blade.

15. The wind turbine blade according to claim 12, wherein said transmitter arrangement is incorporated in or mounted on the wind turbine blade.

16. The wind turbine blade according to claim 12, wherein said at least one transmitter arrangement comprises electromagnetic transmitters.

17. The wind turbine blade according to claim 12, wherein the signals are non-encoded with position indicative data.

18. A wind turbine comprising a wind turbine blade according to claim 12.

19. Use of wireless signals for determination of a position of at least a part of a wind turbine blade, wherein the wireless signals are transmitted wirelessly from the wind turbine blade and wherein the signals are non-encoded with position indicative data.

20. Use of wireless signals for determination of a position of at least a part of a wind turbine blade, wherein the wireless signals are transmitted wirelessly from the wind turbine blade, wherein the signals are non-encoded with position indicative data, and wherein the wind turbine blade is the wind turbine blade according to claim 12.
